(19) United States
(12) Patent Application Publication
(10) Pub. No.: US 2009/0125753 A1
(43) Pub. Date: May 14, 2009

(54) HANDLING OF DATA STORAGE WITHIN A FLASH MEDIA DEVICE

(76) Inventor: Anton Joseph Kryka, Northville, MI (US)

Correspondence Address: UNISYS CORPORATION, UNISYS WAY, MAIL STATION: E8-114, BLUE BELL, PA, 19424, US

(21) Appl. No.: 12/269,932

(22) Filed: Nov. 13, 2008

Related U.S. Application Data
(60) Provisional application No. 61/002,945, filed on Nov. 13, 2007.

(51) Int. Cl. G06F 12/16; G06F 12/02; G06F 11/10

(52) U.S. Cl. 714/6; 711/170; 711/166; 711/103; 711/E12.103; 714/E11.034; 711/E12.008

(57) ABSTRACT

A flash memory device can be subdivided into smaller areas (called chunks) that can written independently over a extended periods of time even though each sector must be erased as a single unit. It may be determined which chunks of data within a sector are valid or invalid and the valid data can be recovered. When errors are detected, the retrieved data may be retrieved from an earlier stored memory chunk in another sector. The type of data stored within a chunk is flagged within that chunk. Each chunk can be date and/or time stamped. Each chunk can also be given a unique, but increasing, sequence number. These values can be used to determine the latest chunk of a particular type.

### RELATED APPLICATIONS

The present application claims the benefit of commonly assigned U.S. Provisional Patent Application entitled “Handling of Data Storage within a Flash Media Device”, Ser. No. 61/002,945, filed Nov. 13, 2007, which is incorporated herein in its entirety.

### FIELD OF THE INVENTION

The present invention relates to handling of data storage within a flash memory device to allow for the recovery of data with the least loss of information and the detection of the various types of errors within a flash memory device.

### BACKGROUND

The purpose of flash memory devices is to retain information through power off cycles. If flash memory devices are powered off during erase or write cycles, the information may not be recoverable.

Detection of an error in a flash memory device is usually performed with a checksum or CRC calculation, but all this does is very that the data is valid or that the data is not valid.

### BRIEF DESCRIPTION OF THE FIGURES

FIG. 1 illustrates a Flash Media device connected to a processing system according to an example embodiment of the present invention.

FIG. 2 illustrates a programmable processing system used with the an embodiment of the present invention.

FIG. 3 shows a possible layout of a flash memory device with each sector divided into chunks according to an embodiment of the present invention.

FIG. 4 illustrates a flowchart of data storage access and error detection processing according to an example embodiment of the present invention.

FIG. 5 illustrates a flowchart for the overall process of data access of a flash media device according to an example embodiment of the present invention.

### SUMMARY OF THE INVENTION

It is, therefore, an object of the present invention to provide backup or redundant storage of data within the flash memory device.

It is another object of the present invention that the type of error that occurred within a flash memory device can be determined.

It is yet another object of the present invention that it can be used with any flash memory device.

In accordance with one aspect of the embodiment of the present invention, the sectors of a flash memory device can be subdivided into smaller areas (called chunks) that can written independently over a extended periods of time even though each sector must be erased as a single unit.

In accordance with another aspect of the embodiment of the present invention, it can be determined which chunks of data within a sector are valid or invalid and the valid data can be recovered.

In accordance with yet another aspect of the embodiment of the present invention, the type of data stored within a chunk is flagged within that chunk.

In accordance with yet another aspect of the embodiment of the present invention, each chunk can be date and/or time stamped. Each chunk can also be given a unique, but increasing, sequence number. These features can be used to determine the latest chunk of a particular type.

### DETAILED DESCRIPTION

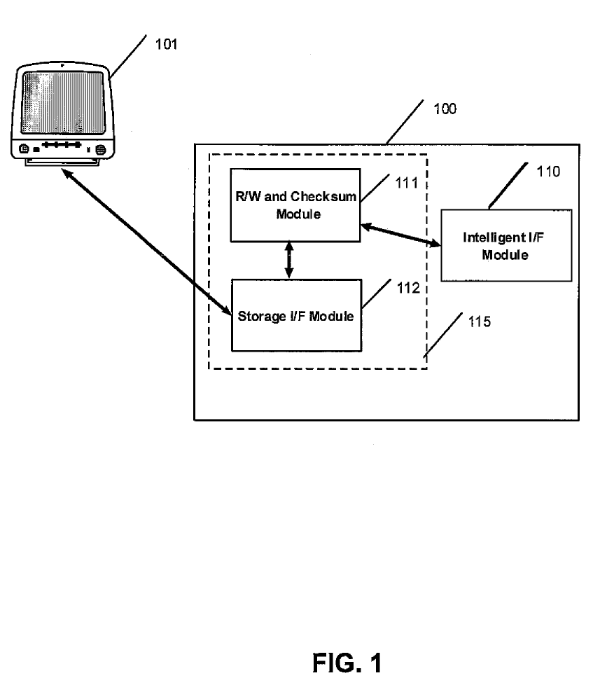

FIG. 1 illustrates a Flash Media device connected to a processing system according to an example embodiment of the present invention. A processing system 101 connects to a flash media storage device 115 to read and write data. In order to read and write data with the storage media 115, and to detect data access errors while reading and writing of data, processing system 101 accesses the media device 115 through a storage interface module 112 and a read/write and checksum module 111 in order to be able to detect data access errors.

In FIG. 1, the storage interface module 112 and a read/write and checksum module 111 are shown to be implemented as data processing modules external to the processing system 101. One of ordinary still in the art will recognize that these modules may also be implemented as processing functions executed within processing system 101 that interacts with a storage media device 115 over a standard interconnection such as a USB interface without deviating from the spirit and scope of the present invention.

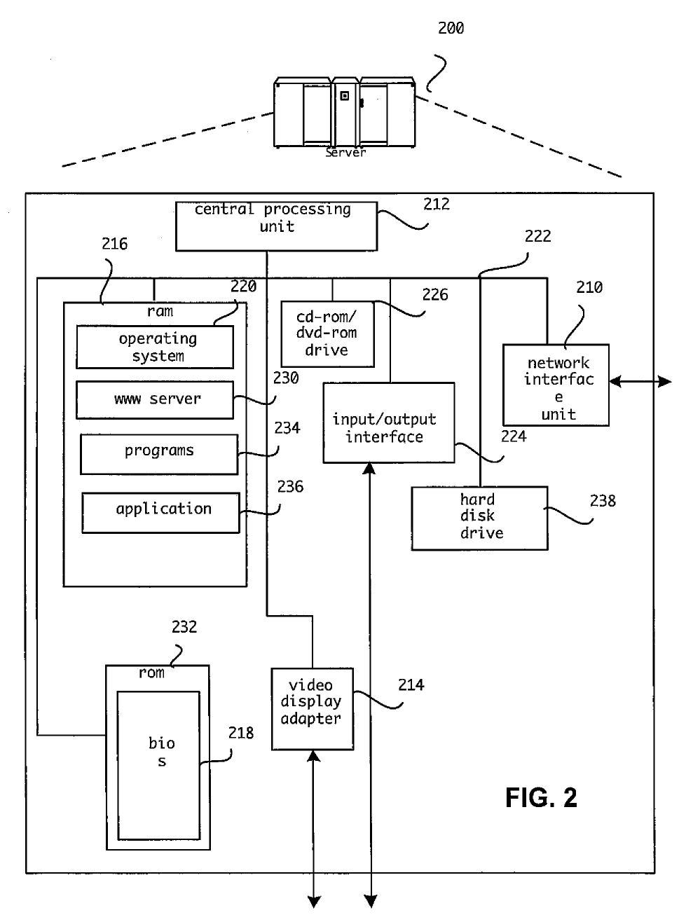

FIG. 2 illustrates a programmable processing system used with an embodiment of the present invention. An exemplary system for implementing the invention includes a programmable processing system 200, including a processor unit 202, a system memory 204, and a system bus 206 that couples various system components including the system memory 204 to the processor unit 200. The system bus 206 may be any of several types of bus structures including a memory bus or memory controller, a peripheral bus and a local bus using any of a variety of bus architectures. The system memory includes read only memory (ROM) 208 and random access memory (RAM) 210. A basic input/output system 212 (BIOS), which contains basic routines that help transfer information between elements within the processing system 200, is stored in ROM 208.

The processing system 200 further includes a hard disk drive 212 for reading from and writing to a hard disk, a magnetic disk drive 214 for reading from or writing to a removable magnetic disk 216, and an optical disk drive 218 for reading from or writing to a removable optical disk 219 such as a CD ROM, DVD, or other optical media. The hard disk drive 212, magnetic disk drive 214, and optical disk drive 218 are connected to the system bus 206 by a hard disk drive interface 220, a magnetic disk drive interface 222, and an optical drive interface 224, respectively. The drives and their associated computer-readable media provide nonvolatile storage of computer readable instructions, data structures, programs, and other data for the processing system 200.

Although the exemplary environment described herein employs a hard disk, a removable magnetic disk 216, and a removable optical disk 219, other types of computer-readable media capable of storing data can be used in the exemplary system. Examples of these other types of computer-readable mediums that can be used in the exemplary operating environment include magnetic cassettes, flash memory cards, digital video disks, Bernoulli cartridges, random access memories (RAMs), and read only memories (ROMs).

A number of program modules may be stored on the hard disk, magnetic disk 216, optical disk 219, ROM 208 or RAM 210, including an operating system 226, one or more application programs 228, other program modules 230, and program data 232. A user may enter commands and information into the processing system 200 through input devices such as a keyboard 234 and mouse 236 or other pointing device. Examples of other input devices may include a microphone, joystick, game pad, satellite dish, and scanner. These and other input devices are often connected to the processing unit 202 through a serial port interface 240 that is coupled to the system bus 206. Nevertheless, these input devices also may be connected by other interfaces, such as a parallel port, game port, or a universal serial bus (USB). A monitor 242 or other type of display device is also connected to the system bus 206 via an interface, such as a video adapter 244. In addition to the monitor 242, personal computers typically include other peripheral output devices (not shown), such as speakers and printers.

The processing system 200 may operate in a networked environment using logical connections to one or more remote computers, such as a remote computer 246. The remote computer 246 may be another personal computer, a server, a router, a network PC, a peer device or other common network node, and typically includes many or all of the elements described above relative to the processing system 200. The network connections include a local area network (LAN) 248 and a wide area network (WAN) 250. Such networking environments are commonplace in offices, enterprise-wide computer networks, intranets, and the Internet.

When used in a LAN networking environment, the processing system 200 is connected to the local network 248 through a network interface or adapter 252. When used in a WAN networking environment, the processing system 200 typically includes a modem 254 or other means for establishing communications over the wide area network 250, such as the Internet. The modem 254, which may be internal or external, is connected to the system bus 206 via the serial port interface 240. In a networked environment, program modules depicted relative to the processing system 200, or portions thereof, may be stored in the remote memory storage device. It will be appreciated that the network connections shown are exemplary, and other means of establishing a communications link between the computers may be used.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

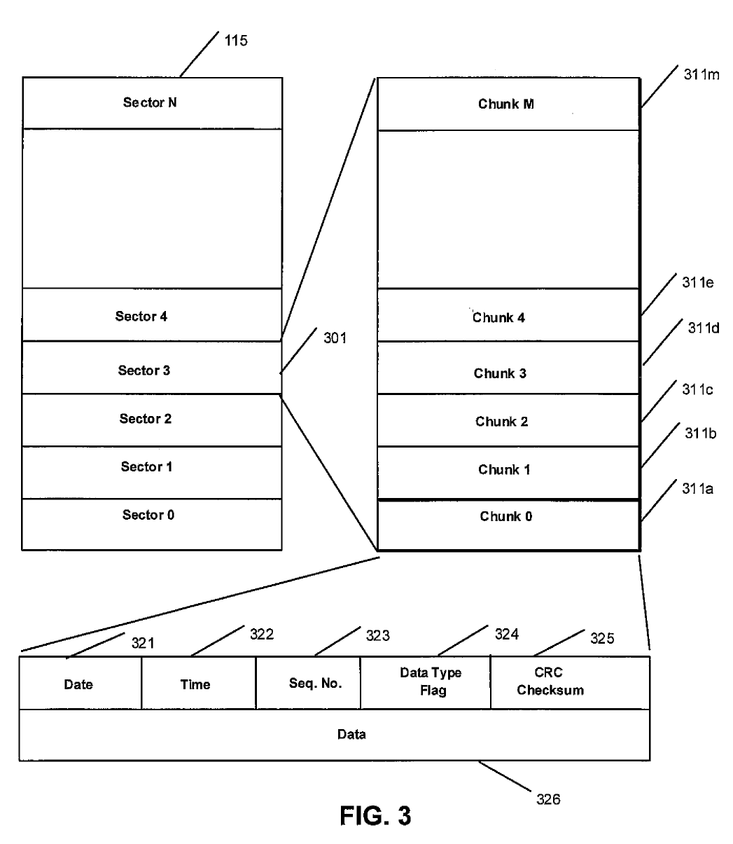

FIG. 3 shows a possible layout of a flash memory device with each sector divided into chunks according to an embodiment of the present invention. Storage media devices 115 are typically organized into a set of sectors. Each sector may be used to store a then current copy of a type of data within the flash storage device. Multiple sectors are used to multiple versions of a type of data with each new version of the data being stored in the next sector.

A particular sector 301 may be organized into a set of blocks of contiguous storage locations that are referred to as chunks 311a-311m. Once a sector is eased, the chunks within a sector are available for data storage. The chunks are typically written sequentially. As each chunk 311c is written it includes a date 321, a time 322, an increasing sequence number 323, or any combination of these depending upon the frequency of the data written. Each chunk contains a flag 324 indicating the type of data within the chunk. Each chunk also includes a checksum 325 or CRC to additionally validate the data 326.

Once all the sectors allocated for a particular type of data storage are written, the sector containing the oldest data can be erased and made available for writing new chunks of data. If dealing with multiple types of data within a single flash memory device, care must be taken that erasing a sector does not erase the only copy of that type of data.

When chunks of data are read back, the newest chunk for a particular type of data is returned. If an error occurs when reading back a chunk of data either through the method described below or through a checksum or CRC failure, the corresponding chunk of data next newest sector containing an earlier version of a type of data may be returned. This does not ensure that no data is lost, but the most recent valid data can be read. To ensure that no data is lost, periodic writes of a particular type of data may be performed. These periodic writes of data will create a

The basic algorithm for detecting flash memory failures that occurred during an erase cycle is to look for the erase pattern of 0xFF's in the beginning of a chunk.

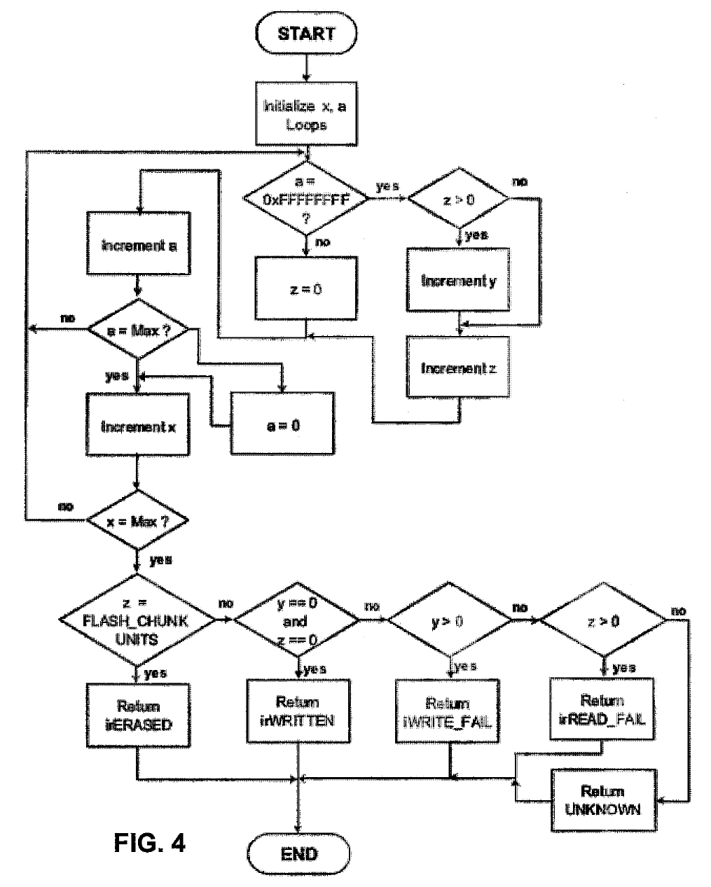

FIG. 4 illustrates a flowchart of data storage access and error detection processing according to an example embodiment of the present invention. The basic algorithm for detecting flash memory failures than occurred during a write cycle is to look for the ease pattern of 0xFF's at the end of a chunk.

The following sample code illustrates these algorithms. The flowchart of FIG. 4 is illustrated in detail in the sample code shown below.

```
    FLASH_CHUNK_UINTS is the size in unsigned integers of
    a chunk of data.
int IsRecordErased(unsigned int *fr)
{
    // fr points to the beginning of a chunk of data
    // the last int of the record must not be 0xFFFFFFFF;
    // it contains the CRC
    // look for string of 0xFFFFFFFFs at the end of the record,
    //  this means that the write failed
    // look for string of 0xFFFFFFFFs at the beginning of the record,
    //  this means that the erase failed
    unsigned int *a = fr;
    int x;
    int y; // count of 0xFFFFFFFFs at beginning of record
    int z; // count of 0xFFFFFFFFs at end of record
    for (x = 0, y = 0, z = 0; x < FLASH_CHUNK_UINTS; a++, x++)
    {
        if (*a == 0xFFFFFFFF
        {
            if (z > 0) y++; // count for every erased word
            z++;
        } else {
            z = 0; // reset erase count if we hit non-erased data
        }
    }
    if (z == FLASH_CHUNK_UINTS) return ireERASED;
    if ((y == 0) && (z == 0)) return ireWRITTEN;
    if (z > 0) return ireWRITE_FAIL;
    if (y > 0) return ireERASE_FAIL;
    return ireUNKNOWN;
}
```

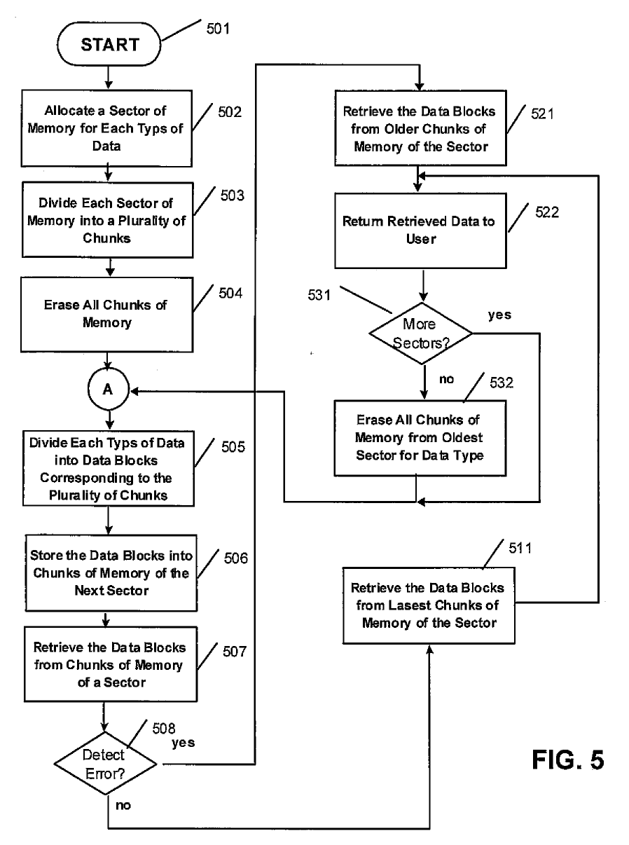

FIG. 5 illustrates a flowchart for the overall process of data access of a flash media device according to an example embodiment of the present invention. The processing begins 501 and memory within the flash media device is allocated into one or more sectors of memory in operation 502. Each of the types of data to be stored within the flash media device are allocated a set of one or more sectors of memory for use in storing the data type.

Each sector of memory in the flash media device are divided into a plurality of chunks of memory in operation 503. All of the chunks of memory in the flash media device are erased in operation 504. This erase operation may be performed by writing a predefined pattern of data into the memory locations of the memory chunks.

The data corresponding to the data types to be stored in the flash media device are divided into a plurality of data blocks corresponding to the size of the memory chunks in operation 505. The size of the memory chunks may also include a data chunk header 321-325 in addition to the data block 326. The data blocks are stored into the corresponding memory chunks along with the data chunk header in operation 506.

When needed, the data blocks 326 are retrieved from the sector of memory containing the newest version of the data type being retrieved along with the data chunk header 321-325 in operation 507. As part of the data retrieval operation, errors are detected in operation 508. The errors may be detected using a CRC value and/or a checksum value stored within the data chunk header 321-325 as discussed above. Additionally, the error may also be detected by searching for erased data errors are discussed above with respect to FIG. 4.

If no errors are detected in test operation 508, data is retrieved from the chunks of memory corresponding to the latest stored data in operation 511 and the retrieved data is returned to a user in operation 522. If errors are detected in test operation 508, data is retrieved from the chunks of memory corresponding to the older stored data in operation 521 and the retrieved data is returned to a user in operation 522.

Test operation 531 determines if addition unused sectors of memory allocated to the particular data type exist. If test operation 531 determines that no addition sectors of memory exist the sector of memory corresponding to the oldest version of the particular data types is erased in operation 532 and the processing returns to operation 505. If test operation 531 determines that addition sectors of memory exist, the processing returns directly to operation 505.

The foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. Thus the present invention is presently embodied as a method, apparatus, computer storage medium or propagated signal containing a computer program for providing a method, apparatus, and article of manufacture providing web services for image processing in a document processing environment.

What is claimed is:

1. A method of storing and retrieving data within a memory device, the method comprises:
allocating at least one memory sector for each data type to be stored within the memory device;
dividing each memory sector into a plurality of memory chunks;
erasing all memory locations within each memory chunks;
dividing data of the data type into a plurality of data blocks corresponding to the size of the memory chunks;
storing the data blocks into the corresponding newest memory chunks;
retrieving the data blocks from the corresponding memory chunks;
detecting data errors within the data blocks retrieved from the memory device;
if data errors are detected in a retrieved data blocks, retrieve the data block from a next oldest sector of the data type corresponding to the memory chunk in the newest memory chunk having an error; and
returning to a user data of the data type containing data blocks retrieved without an error.

2. The method according to claim 1, wherein the method further comprising:
if no data errors are detected in the retrieved data blocks, returning to a user data of the data type containing data blocks retrieved without an error.

3. The method according to claim 1, wherein the detecting an error is performed using a CRC checksum.

4. The method according to claim 1, wherein the detecting an error is detecting an incorrect erased memory block pattern.

5. The method according to claim 1, wherein the memory device corresponds to a flash media device.

6. The method according to claim 1, wherein the data blocks stored within the memory chunks comprises a data chunk header and data.

7. The method according to claim 6, wherein the data chunk header comprises a date field, a time field, a sequence number field, a data type flag field, and a CRC checksum field.

8. A computer-readable storage medium containing encoded data corresponding to computer readable instructions for a programmable computer system for implementing a method of storing and retrieving data within a memory device, the method comprises:
allocating at least one memory sector for each data type to be stored within the memory device;
dividing each memory sector into a plurality of memory chunks;
erasing all memory locations within each memory chunks;
dividing data of the data type into a plurality of data blocks corresponding to the size of the memory chunks;
storing the data blocks into the corresponding newest memory chunks;
retrieving the data blocks from the corresponding memory chunks;
detecting data errors within the data blocks retrieved from the memory device;
if data errors are detected in a retrieved data blocks, retrieve the data block from a next oldest sector of the data type corresponding to the memory chunk in the newest memory chunk having an error; and
returning to a user data of the data type containing data blocks retrieved without an error.

9. The computer-readable storage medium according to claim 8, wherein the method further comprising:
if no data errors are detected in the retrieved data blocks, returning to a user data of the data type containing data blocks retrieved without an error.

10. The computer-readable storage medium according to claim 8, wherein the detecting an error is performed using a CRC checksum.

11. The computer-readable storage medium according to claim 8, wherein the detecting an error is detecting an incorrect erased memory block pattern.

12. The computer-readable storage medium according to claim 8, wherein the memory device corresponds to a flash media device.

13. The computer-readable storage medium according to claim 8, wherein the data blocks stored within the memory chunks comprises a data chunk header and data.

14. The computer-readable storage medium according to claim 13, wherein the data chunk header comprises a date field, a time field, a sequence number field, a data type flag field, and a CRC checksum field.
